(19) United States
(12) Patent Application Publication
(10) Pub. No.: US 2013/0123028 A1
(43) Pub. Date: May 16, 2013

(54) ROBOT ARM ASSEMBLY

(71) Applicant: BO LONG, Shenzhen City (CN)

(72) Inventor: BO LONG, Shenzhen City (CN)

(21) Appl. No.: 13/651,630

(22) Filed: Oct. 15, 2012

(30) Foreign Application Priority Data
Nov. 11, 2011 (CN) 201110356851.6

(51) Int. Cl. F16H 1/26

(52) U.S. Cl. 464/147

(57) ABSTRACT

A robot arm assembly includes a plurality of driving members, a first transmission mechanism, a second transmission mechanism, and a third transmission mechanism. The first transmission mechanism includes a first rotating shaft, and a second rotating shaft. One end of the first rotating shaft is connected to the first driving member by the connecting member, the other end of the first rotating shaft is movably connected to the second rotating shaft, and the first driving member drives the first rotating shaft to rotate a predetermined number of degrees. The second and third transmission mechanisms include several connecting members and jointing members, transmission members and shafts, and gear wheels.

### BACKGROUND

1. Technical Field

The present disclosure generally relates to industrial robots, and particularly to a robot arm assembly.

2. Description of Related Art

An industrial robot, such as a six-axis robot, may include a plurality of motors and a plurality of transmission mechanisms. To execute specific tasks, one motor drives one transmission mechanism to rotate an actuator, such as a detector, a welding device, a gripper, or a cutting tool. A mechanical arm used for containing the transmission mechanisms is typically too long; the transmission mechanisms for driving the mechanical arms are also too long. In order to reduce the space for containing the transmission mechanisms, rotating shafts of the transmission mechanisms may be substantially hollow sleeves, and one of the rotating shafts is sleeved on another rotating shaft. However, it is difficult to manufacture the rotating shafts because the sidewall of the rotating shafts is relatively thin and long.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a robot arm assembly.

FIG. 2 is an assembled, isometric view of the robot arm assembly of FIG. 1 without a housing.

FIG. 3 is an exploded, isometric view of the robot arm assembly of FIG. 2.

FIG. 4 is a cross-sectional view of the robot arm assembly of FIG. 1, taken along the line IV-IV.

FIG. 5 is an enlarged view of a circled portion V of FIG. 4.

### DETAILED DESCRIPTION

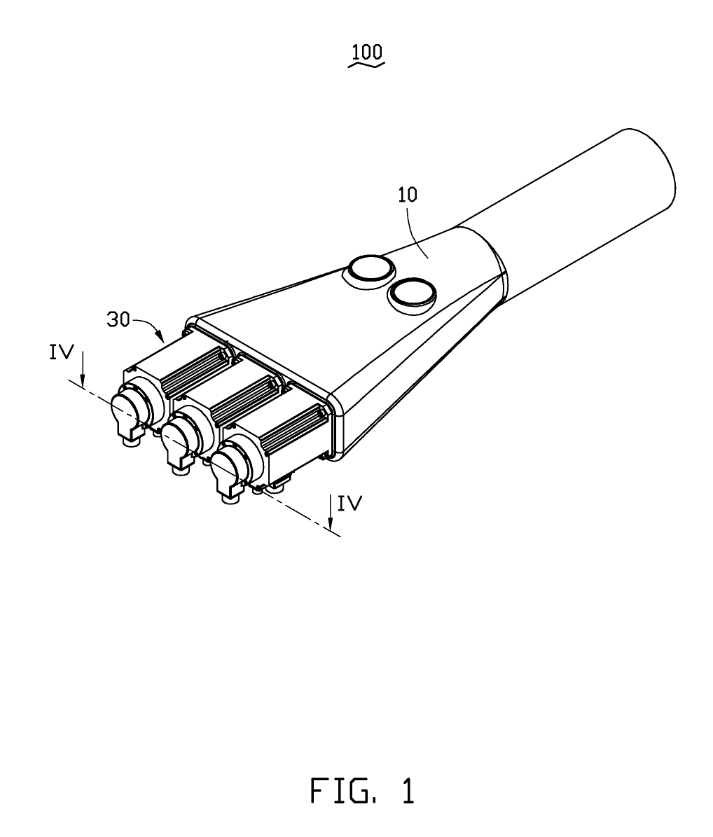

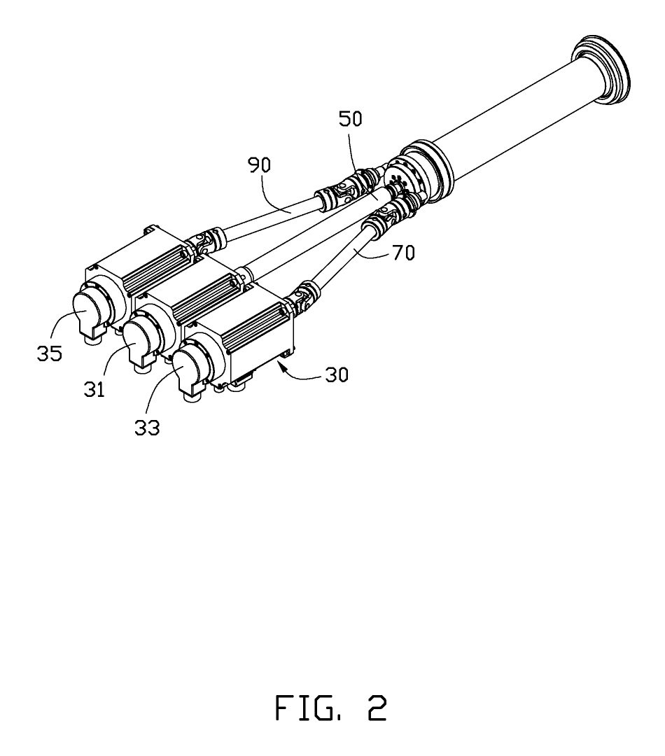

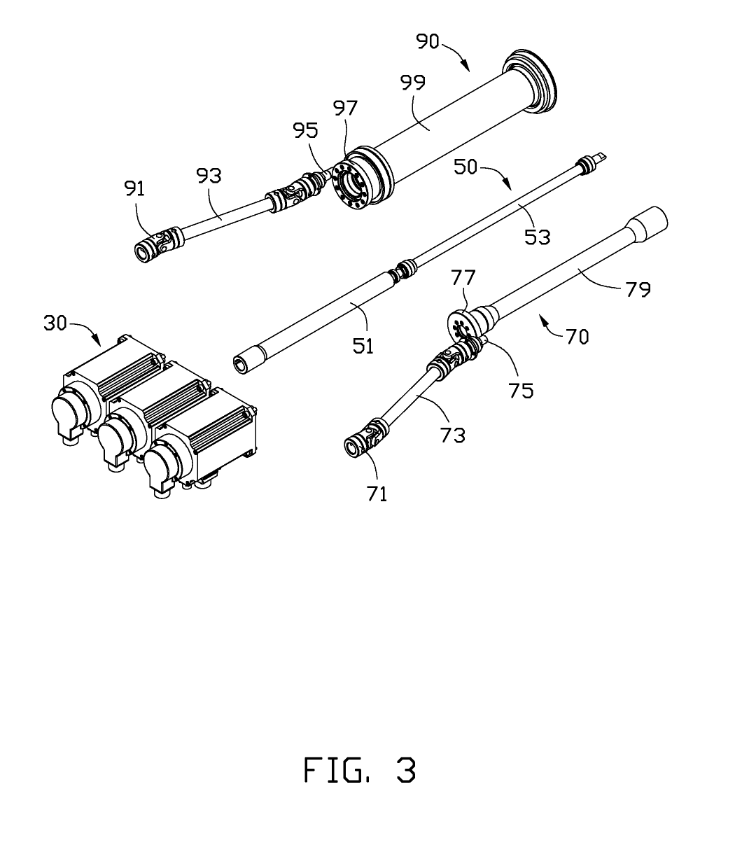

Referring to FIGS. 1 through 3, an embodiment of a robot arm assembly 100 is shown. The robot arm assembly 100 includes a housing 10, a driving mechanism 30, a first transmission mechanism 50, a second transmission mechanism 70, and a third transmission mechanism 90. The first transmission mechanism 50, the second transmission mechanism 70, and the third transmission mechanism 90 are all movably received in the housing 10, and the first transmission mechanism 50 is located between the second transmission mechanism 70 and the third transmission mechanism 90. The driving mechanism 30 is mounted on one end of the housing 10 to drive the first transmission mechanism 50, the second transmission mechanism 70, and the third transmission mechanism 90. An actuator, such as a detector, a welding device, a gripper or a cutting tool, is mounted on the other end of the housing 10 to execute specific tasks. In the illustrated embodiment, the robot arm assembly 100 is applied to a six-axis robot (not shown).

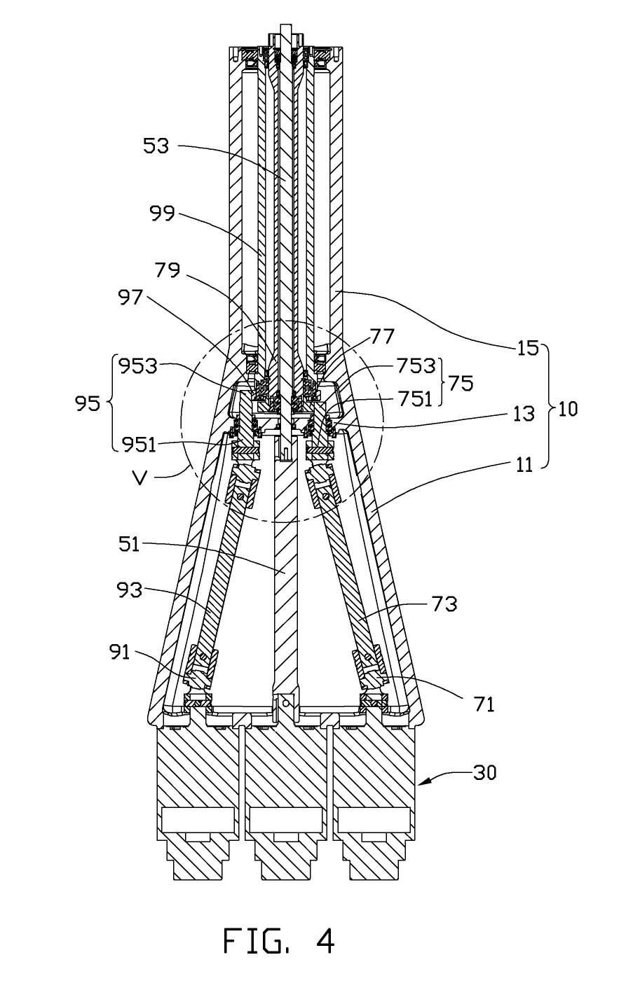

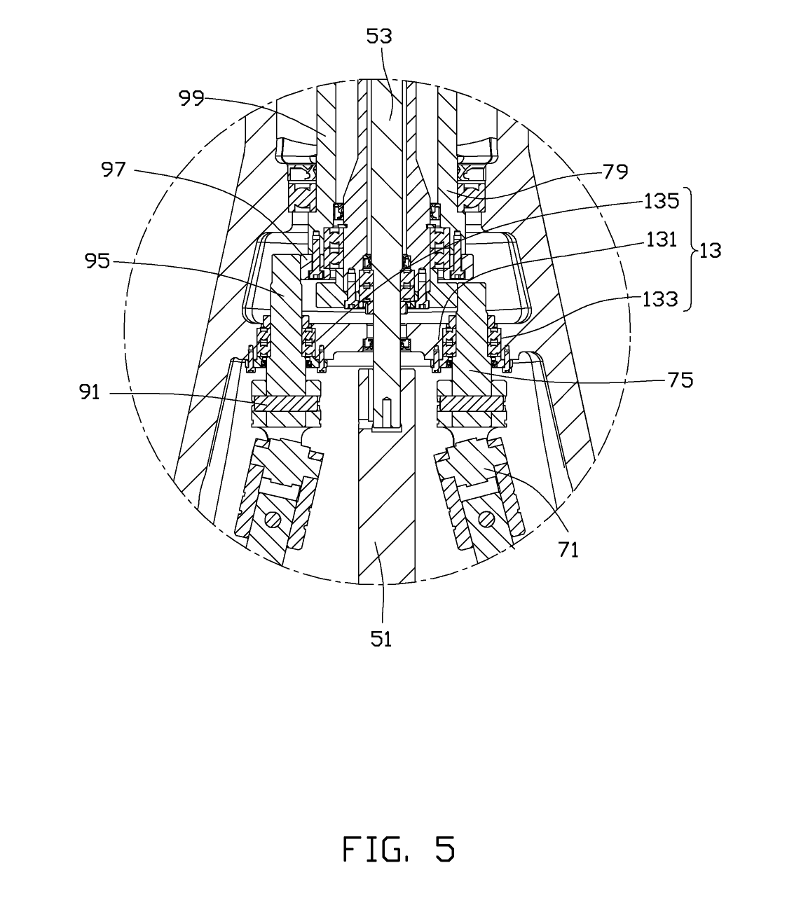

Referring to FIGS. 4 and 5, the housing 10 is a substantially hollow sleeve, and includes a main portion 11, a mounting portion 13 and an extending portion 15. The extending portion 15 extends outward from an end of the main portion 11. The mounting portion 13 is formed in one end of the main portion 11 adjacent to the extending portion 15. In the illustrated embodiment, the longitudinal section of the main portion 11 is a trapezoid, the extending portion 15 is a hollow cylinder, and the extending portion 15 is connected to the narrow end of the main portion 11. The mounting portion 13 defines a first mounting hole 131 at about the center of the mounting portion 13, a second mounting hole 133 and a third mounting hole 135 at opposite sides of the first mounting hole 131. The first mounting hole 131 is located between the second mounting hole 133 and the third mounting hole 135.

The driving mechanism 30 includes a first driving member 31, a second driving member 33, and a third driving member 35. The first driving member 31 is located between the second driving member 33 and the third driving member 35. The first driving member 31 is used for driving the first transmission mechanism 50, the second driving member 33 is used for driving the second transmission mechanism 70, and the third driving member 35 is used for driving the third transmission mechanism 90. In the illustrated embodiment, the first driving member 31, the second driving member 33, and the third driving member are all motors. In alternative embodiments, any one of the first driving member 31, the second driving member 33, and the third driving member 35 may be an air-powered rotating cylinder.

The first transmission mechanism 50 includes a first rotating shaft 51 and a second rotating shaft 53 non-rotatably connected to an end of the first rotating shaft 51. The first rotating shaft 51 and the second rotating shaft 53 are both substantially cylindrical, the first rotating shaft 51 is received in the main portion 11 of the housing 10, and the second rotating shaft 53 is received in the extending portion 15 of the housing 10. One end of the second rotating shaft 53 passes through the first mounting hole 131 and is non-rotatably connected to one end of the first rotating shaft 51, the other end of second rotating shaft 51 is connected to an actuator, such as a detector, a welding device, a gripper or a cutting tool, and the other end of the first rotating shaft 51 is connected to the first driving member 31.

The second transmission mechanism 70 includes two connecting members 71, a first transmission member 73, a first gear wheel 75, a second gear wheel 77, and a second transmission member 79. The first transmission member 73 is substantially a cylinder, and is received in the main portion 11. The second transmission member 79 is a substantially hollow cylinder, and is sleeved on the second rotating shaft 53. The first gear wheel 75 includes a base portion 751 and a gear portion 753 formed on an end of the base portion 751. The gear portion 753 passes through the second mounting hole 133. The second gear wheel 77 is non-rotatably sleeved on an end of the second transmission member 79 adjacent to the first gear wheel 75, and meshes with the gear portion 753. One connecting member 71 connects the first transmission member 73 and the second driving member 33, and the second driving member 33 drives the first transmission member 73 to rotate a predetermined number of degrees. The other connecting member 71 connects the first transmission member 73 and the first gear wheel 75, respectively, and the first transmission member 73 drives the first gear wheel 75 to rotate a predetermined number of degrees, and first gear wheel 75 drives the second gear wheel 77 to rotate the second transmission member 79.

The third transmission mechanism 90 is similar to the second transmission mechanism 70. The third transmission mechanism 90 includes two jointing members 91, a first transmission shaft 93, a first gear wheel 95, a second gear 97, and a second transmission shaft 99. The first transmission shaft 93 is substantially a cylinder, and is received in the main portion 11. The second transmission shaft 99 is a substantially hollow cylinder, and is sleeved on the second transmission member 79. The first gear wheel 95 includes a base portion 951 and a gear portion 953 formed on an end of the base portion 951. One end of the base portion 951 connected with the gear portion 953 passes through the third mounting hole 135. The second gear wheel 97 is non-rotatably sleeved on an end of the second transmission shaft 99 adjacent to the first gear wheel 95, and meshes with the gear portion 953. One jointing member 91 connects the first transmission shaft 93 and the third driving member 35, and the third driving member 35 drives the first transmission shaft 93 to rotate a predetermined number of degrees. The other jointing member 91 connects the first transmission shaft 93 and the first gear wheel 95, and the first transmission shaft 93 drives the first gear wheel 95 to rotate a predetermined number of degrees, and the first gear wheel 95 drives the gear portion 97 to rotate the second transmission shaft 99.

In the illustrated embodiment, the two connecting members 71 and the two jointing members 91 are all universal joints. In alternative embodiments, any of the two connecting members 71 and the two jointing members 91 may be a hinge.

In use, the first driving member 31 drives the first rotating shaft 51 and the second rotating shaft 53 to rotate, the second rotating shaft 53 drives the actuator connecting to the second rotating shaft 53 to rotate. The second driving member 33 drives the first transmission member 73 to rotate a predetermined number of degrees by one connecting member 71; the first transmission member 73 drives the first gear wheel 75 and the second gear wheel 77 to rotate a predetermined number of degrees by the other connecting member 71. The third driving member 35 drives the first transmission shaft 93 to rotate a predetermined degree by one jointing member 91, the first transmission shaft 93 drives the first gear wheel 95 and the second gear wheel 97 to rotate a predetermined number of degrees by the other jointing member 91.

The second transmission mechanism 70 is divided into a plurality of sections by the two connecting members 71, and the third transmission mechanism 90 is divided into a plurality of sections by the two jointing members 91, which reduces the overall length of a single unit of the second transmission mechanism 70 and the third transmission mechanism 90. Therefore, it is convenient to manufacture the robot arm assembly 100.

In alternative embodiments, the first transmission mechanism 50 may include two connecting members, which are the same as the connecting members 71, fastened to two ends of the first rotating shaft 51. One of the two connecting members connects the first rotating shaft 51 and the first driving member 31, and the other connecting member connects the first rotating shaft 51 and the second rotating shaft 53. At this time, any one of the second transmission mechanism 70 and the third transmission mechanism 90 can be omitted, and any one of the second driving member 33 and the third driving member 35 is omitted, correspondingly.

In alternative embodiments, the first transmission mechanism 50 may include one connecting member, that is the same as the connecting member 71. The first rotating shaft 51 connects the first driving member 31 by the connecting member. At this time, any one of the second transmission mechanism 70 and the third transmission mechanism 90 can be omitted, and any one of the second driving member 33 and the third driving member 35 is omitted, correspondingly.

In an alternative embodiment, the third transmission mechanism 90 can be omitted, and the third driving member 35 is omitted, correspondingly.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A robot arm assembly, comprising:
a first driving member;
a first transmission mechanism comprising a connecting member, a first rotating shaft, and a second rotating shaft, wherein one end of the first rotating shaft is connected to the first driving member by the connecting member, the other end of the first rotating shaft is movably connected to the second rotating shaft, and the first driving member drives the first rotating shaft to rotate a predetermined number of degrees.

2. The robot arm assembly of claim 1, further comprises a second driving member and a second transmission mechanism, the second transmission mechanism comprises two connecting members, a first transmission member, a first gear wheel, a second gear wheel meshing with the first gear wheel, and a second transmission member, one of the two connecting members of the second transmission mechanism connects the second driving member and the first transmission member, the second gear wheel is fastened to one end of the second transmission member adjacent to the first gear wheel, the first transmission member is connected to the first gear wheel by the other one of the two connecting members of the second transmission mechanism, the second driving member drives the first transmission member to rotate a predetermined number of degrees, and the first transmission member drives the first gear wheel to rotate a predetermined number of degrees.

3. The robot arm assembly of claim 2, wherein the second transmission member is a sleeve, and the second rotating shaft is received in the second transmission member.

4. The robot arm assembly of claim 2, further comprises a third driving member and a third transmission mechanism, the third transmission mechanism comprises two jointing members, a first transmission shaft, a first gear wheel, a second gear wheel meshing with the first gear wheel, and a second transmission shaft, one of the two jointing members connects the third driving member and the first transmission shaft, the second gear wheel of the third transmission mechanism is fastened to one end of the second transmission shaft adjacent to the first gear wheel of the third transmission mechanism, the first transmission shaft connects to the first gear wheel of the third transmission mechanism by the other one of the two jointing members, the third driving member drives the first transmission shaft to rotate a predetermined number of degrees, and the first transmission shaft drives the first gear wheel of the third transmission mechanism to rotate a predetermined number of degrees.

5. The robot arm assembly of claim 4, wherein the second transmission shaft is a sleeve, and the second transmission shaft is sleeved on the second transmission member.

6. The robot arm assembly of claim 4, further comprises a housing comprising a main portion, a mounting portion, and an extending portion, the extending portion extends from an end of the main portion outward, and the mounting portion is formed in one end of the main portion adjacent to the extending portion, the first driving member is mounted on an end of the main portion away from the extending portion, the first transmission member is received in the main portion, and the second transmission member is received in the extending portion.

7. The robot arm assembly of claim 6, wherein the mounting portion defines a first mounting hole at about the center portion thereof, the first driving member is fastened to an end of the main portion away from the extending portion, the first rotating shaft is received in the main portion, and the second rotating shaft is received in the extending portion and an end of the second rotating shaft extends through the first mounting hole to fastened to the first rotating shaft.

8. The robot arm assembly of claim 7, wherein the mounting portion further defines a second mounting hole and a third mounting hole at opposite sides of the first mounting hole, an end of the first gear wheel of the second transmission mechanism passes through the second mounting hole, and an end of the first gear wheel of the third transmission mechanism passes through the third mounting hole.

9. The robot arm assembly of claim 1, wherein the two connecting members are both universal joints.

10. A robot arm assembly comprising:
a first driving member;
a first transmission mechanism comprising a first rotating shaft connected to the first driving member and a second rotating shaft connected to the first rotating shaft;
a second driving member;
a second transmission mechanism comprising two connecting members, a first transmission member, a first gear wheel, a second gear wheel meshing with the first gear wheel, and a second transmission member, wherein one of the two connecting members connects the second driving member and the first transmission member, the second gear wheel is fastened to one end of the second transmission member adjacent to the first gear wheel, the first transmission member is connected to the first gear wheel by the other one of the two connecting members, the second transmission member is sleeved on the second rotating shaft, the second driving member drives the first transmission member to rotate a predetermined number of degrees, and the first transmission member drives the first gear wheel to rotate a predetermined number of degrees.

11. The robot arm assembly of claim 10, further comprises a housing comprising a main portion, a mounting portion, and an extending portion, the extending portion extends from an end of the main portion outward, and the mounting portion is formed in one end of the main portion adjacent to the extending portion, the first driving member is mounted on an end of the main portion away from the extending portion, the first transmission member is received in the main portion, and the second transmission member is received in the extending portion.

12. The robot arm assembly of claim 11, wherein the first rotating shaft and the first transmission member are received in the main portion, and the second rotating shaft and the second transmission member are received in the extending portion.

13. The robot arm assembly of claim 12, wherein the mounting portion defines a first mounting hole thereof, and an end of the second rotating shaft passes through the first mounting hole to fasten to the first rotating shaft.

14. The robot arm assembly of claim 13, wherein the mounting portion further defines a second mounting hole adjacent to the first mounting hole thereof, the first gear wheel comprises a base portion and a gear portion formed on an end of the base portion, and the gear portion passes through the second mounting hole to mesh with the second gear wheel.

15. The robot arm assembly of claim 10, wherein the second transmission member is a sleeve, and the second rotating shaft is received in the second transmission member.

16. The robot arm assembly of claim 14, further comprises a third driving member and a third transmission mechanism, the third transmission mechanism comprises two jointing members, a first transmission shaft received in the main portion, a first gear wheel, a second gear wheel meshing with the first gear wheel, and a second transmission shaft received in the extending portion, one of the two jointing members connects the third driving member and the first transmission shaft, the second gear wheel of the third transmission mechanism is fastened to one end of the second transmission shaft adjacent to the first gear wheel of the third transmission mechanism, the first transmission shaft connects to the first gear wheel of the third transmission mechanism by the other one of the two jointing members, the third driving member drives the first transmission shaft to rotate a predetermined number of degrees, and the first transmission shaft drives the first gear wheel of the third transmission mechanism to rotate a predetermined number of degrees.

17. The robot arm assembly of claim 16, wherein the second transmission shaft is a sleeve, and the second transmission shaft is sleeved on the second transmission member.

18. The robot arm assembly of claim 17, wherein the mounting portion further defines a third mounting hole adjacent to the first mounting hole thereof, the first gear wheel of the third transmission mechanism comprises a base portion and a gear portion formed on an end of the base portion of the third transmission mechanism, and the gear portion of the third transmission mechanism passes through the third mounting hole to mesh with the second gear wheel of the third transmission mechanism.

19. The robot arm assembly of claim 10, wherein the two connecting members are both universal joints.

20. The robot arm assembly of claim 16, wherein the two jointing members are both universal joints.
